(19) United States
(12) Patent Application Publication
(10) Pub. No.: US 2008/0256797 A1
(43) Pub. Date: Oct. 23, 2008

(54) Gas Bearings (Laser)

(76) Inventor: Bjorn Lind, Goteborg (SE)

Correspondence Address: SCHWEGMAN, LUNDBERG & WOESSNER, P.A., P.O. BOX 2938, MINNEAPOLIS, MN, 55402, US

(21) Appl. No.: 11/794,553

(22) PCT Filed: Nov. 28, 2005
(86) PCT No.: PCT/SE05/01788

§ 371 Date: Mar. 25, 2008

(30) Foreign Application Priority Data
Jan. 13, 2005 (SE) 0500093-0

(51) Int. Cl. B23K 26/38

(52) U.S. Cl. 29/898.02

(57) ABSTRACT

Method for gas bearings comprising two relatively rotating parts, one part of which consists of a spindle shaft and the other part of which is provided with a bearing surface and is made from a material through which gas can be conducted to the bearing gap, for producing holes conducting gas to the bearing surface, distinguished by the steps: (a) with the aid of a high-energy beam directed towards the bearing surface, a certain number of first holes smaller than the final number of holes calculated from experience are made in the bearing surface to make a primary airflow through this part of the bearing surface possible; (b) the preliminary airflow is measured; (c) on the basis of the measured airflow, the exact number necessary of additional second holes to be made in order to obtain the desired necessary airflow is calculated; (d) the calculated number of additional second holes are made in the bearing surface.

The present invention relates to a method for gas bearings according to the precharacterizing clause of patent claim 1.

Gas bearings are well known within the art and are described in the German publication DE 44 36 156 and the European publication EP 0 237 627, for example. Gas bearings are used at high rotational speeds between the bearing parts, for example a spindle shaft and the bearing surface supporting it. In order to obtain good functioning of a gas bearing, it is desirable to have a material combination between the relatively rotating parts which does not damage the parts when they make contact with one another during rotation and makes partial melting as a result of the frictional heat developed impossible. In order to avoid this disadvantage, use is made of a non-metallic material in the bearing surface, for example graphite. In this connection, it is known to use porous graphite throughout the bearing surface, which affords good gas permeability and thus good functioning, but the weakness is that the porous graphite has poor wear resistance, which results in the gas bearing being deformed rapidly as a consequence of the contact between the shaft and the bearing surface.

In order to eliminate this weakness, the graphite bearing is designed with a wear-resistant bearing surface made of solid graphite, for example, through which gas-permeable holes are made, which communicate with the gas-generating source via the graphite bearing part located outside the bearing surface.

In the manufacture of bearings of this type, the holes are produced in a suitable way by drilling or with the aid of a high-energy beam, for example a focussed laser beam. The use of a high-energy beam makes it possible to make holes directly in the bearing surface in the case of shaft bearings located on the outside. One difficulty of the hole-making process, however, is deciding how many holes the bearing surface concerned is to have in order to meet the necessary requirements. The “calculation” of the number of holes is based entirely on experience, which is of course to a great extent also influenced by the diameter and length and repeatability of the holes, which means that in some cases too few holes and in some cases too many holes are made in a bearing. Both eventualities mean that the bearing cannot function optimally. A way of being able to decide more accurately in advance how many holes the bearing in question requires in order to obtain the desired flow has not yet seen the light of day.

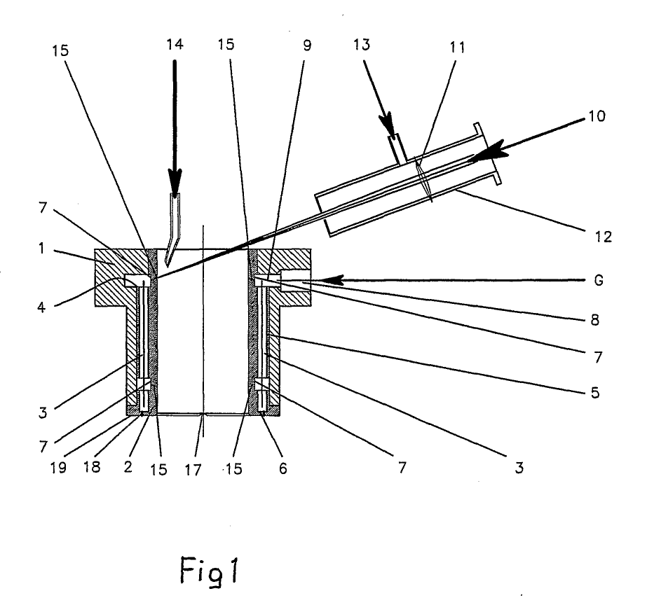

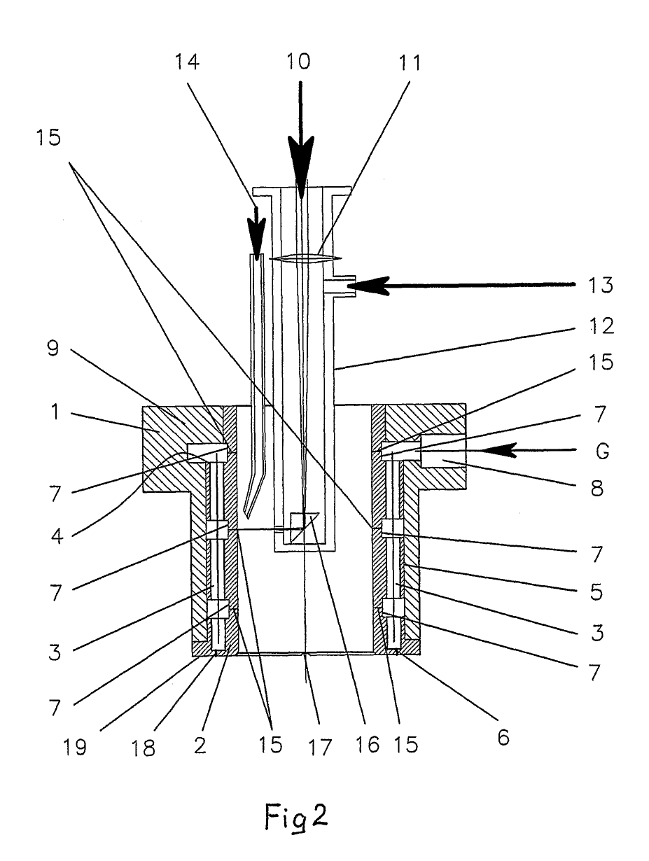

However, this is possible by virtue of the invention having been provided with the characteristics indicated in the patent claims. The invention will be described in greater detail in the form of examples with reference to the drawing, in which FIGS. 1 and 2 show different ways of making holes in the bearing surface with the aid of a high-energy beam.

In the figures, 1 designates a bearing housing in which a shaft bearing 2 is accommodated. The bearing 1 consists of a material suitable for gas bearings, for example graphite, in which the bearing surface has been made wear-resistant by the use of solid graphite, for example. The bearing 2 has a number of axial bores 3, distributed around the bearing, starting from a shoulder 4 of an enlarged part 5 of the bearing and ending in the latter at 6. Turned cavities 7, which form thinner regions of the gas bearing material inside its wear-resistant bearing surface, extend from the bores 3.

Gas under pressure (indicated by G) is supplied via a connection 8 to a circular turned cavity 9 with which the bores 3 communicate. FIG. 1 indicates how a hole 15 is made in the gas bearing and through the wear-resistant bearing surface made of solid graphite, for example, with the aid of a high-energy beam, in this case a focussed laser beam 10. The laser beam 10 is refracted by a lens 11 in a protective pipe 12, which is supplied via 13 with protective air in order to prevent the particles reaching the lens. Air is supplied at 14 in order to blow away gasified material when the holes are made. The holes are indicated in the figures by the designation 15. In the case of this method, holes 15 can scarcely be made other than in the axially outer parts of the bearing.

FIG. 2 shows an embodiment in which the high-energy beam is directed towards the bearing surface via a deflection by means of a prism 16, for example, which makes it possible to make gas-permeable holes in the central region of the bearing as well.

By virtue of the methods shown, it is now possible to make a desired number of holes located in freely selected locations in the bearing in a flexible way. By virtue of this, a method is made possible in which, with the aid of a high-energy beam directed towards the bearing surface, a certain number of first holes smaller than the final number of holes calculated from experience are made in the bearing surface with desired positioning. This makes a primary airflow through the bearing surface possible. This preliminary airflow is measured and, on the basis of the value obtained in this connection, the exact number of additional second holes with the same characteristics can be calculated in order that the necessary airflow for the bearing will be obtained. The additional calculated number of second holes is made in order that the desired necessary airflow will be obtained.

During implementation, half the number of holes estimated from the outset from experience are suitably made. The smaller number of first holes are suitably positioned in a uniformly distributed manner over 360 degrees along one or more circular lines in the bearing surface, after which the calculated number of additional second holes are made with corresponding positioning along one or more circular lines displaced axially in relation to the first holes. A simple method for carrying this out is for the bearing surface in which the gas-permeable channels are to be made to be rotated stepwise and displaced axially in relation to the stationary high-energy beam.

In the event that the bearing according to the invention is a combined radial and axial bearing, channels 18 are formed, extending between the bores 3 and the axial bearing surface 19, and are fed with “radial bearing air” via the bores 3. Both “radial bearing air” and “axial bearing air” are evacuated from the region between the radial bearing surface and the axial bearing surface at a countersink 17 made in the axial bearing surface.

1. Method for gas bearings comprising two relatively rotating parts, one part of which consists of a spindle shaft and the other part of which is provided with a bearing surface and is made from a material through which gas can be conducted to the bearing gap, for producing holes conducting gas to the bearing surface, comprising:
with the aid of a high-energy beam directed towards the bearing surface, a certain number of first holes smaller than the final number of holes calculated from experience are made in the bearing surface to make a primary airflow through this part of the bearing surface possible;
the preliminary airflow is measured;
on the basis of the measured airflow, the exact number necessary of additional second holes to be made in order to obtain the desired necessary airflow is calculated; and
the calculated number of additional second holes are made in the bearing surface.

2. Method according to claim 1, characterized in that the smaller number of first holes is of the order of half the calculated number.

3. Method according to claim 2, wherein the smaller number of first holes are made in a uniformly distributed manner over 360 degrees along one or more circular lines in the bearing surface, and the number of additional second holes with the same characteristics are made with similar positioning along one or more circular lines displaced axially in relation to the first holes.

4. Method according to claim 3, characterized in that that part of the bearing surface in which the gas-permeable channels are to be made is rotated and displaced axially in relation to a stationary high-energy beam.

5. Method according to claim 4, wherein the high-energy beam is a focused laser beam directed directly towards the bearing surface.

6. Method according to claim 1, wherein the high-energy beam is a focused laser beam directed towards the bearing surface via a deflection by means of a prism.

7. A method according to claim 2, wherein the high-energy beam is a focused laser beam directed towards the bearing surface via a deflection by means of a prism.

8. A method according to claim 3, wherein the high-energy beam is a focused laser beam directed towards the bearing surface via a deflection by means of a prism.

9. A method according to claim 4, wherein the high-energy beam is a focused laser beam directed towards the bearing surface via a deflection by means of a prism.

10. A method according to claim 1, wherein the smaller number of first holes are made in a uniformly distributed manner over 360 degrees along one or more circular lines in the bearing surface, and the number of additional second holes with the same characteristics are made with similar positioning along one or more circular lines displaced axially in relation to the first holes.

11. A method according to claim 10, wherein part of the bearing surface in which the gas-permeable channels are to be made is rotated and displaced axially in relation to a stationary high-energy beam.

12. A method according to claim 11, wherein the high-energy beam is a focused laser beam directed directly towards the bearing surface.

13. A method according to claim 10, wherein the high-energy beam is a focused laser beam directed towards the bearing surface via a deflection by means of a prism.

14. A method for producing a gas bearing structure, comprising:
directing an energy beam to produce a first number of holes in bearing;
flowing gas through the first number of holes;
measuring the gas flow;
calculating a second number of holes to be formed in the bearing based on the measured gas flow so that a certain gas flow would be achieved; and
directing an energy beam to produce a second number of holes in the bearing based on the calculated second number of holes.
